(19) United States
(12) Patent Application Publication
(10) Pub. No.: US 2010/0182076 A1
(43) Pub. Date: Jul. 22, 2010

(54) SEMICONDUCTOR INTEGRATED CIRCUIT DEVICE

(75) Inventors: Hiroyuki MIZUNO, Musashino (JP); Kiyoo ITOH, Higashikurume (JP); Masanao YAMAOKA, Kodaira (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/688,967

(22) Filed: Jan. 18, 2010

(30) Foreign Application Priority Data
Jan. 20, 2009 (JP) JP2009-009890

(51) Int. Cl. G05F 1/10

(52) U.S. Cl. 327/543

(57) ABSTRACT

A semiconductor integrated circuit device achieving an active state in which a high speed operation is performed and an inactive state in which a low leakage state is retained while an internal logical state is retained, and a transition between the two states can be achieved at high speed with low noise and low power. A power control circuit provided between a first power-supply line for providing a first external power-supply voltage and a second power-supply line for providing a second external power-supply voltage includes an output MOSFET. A constant OFF current flows in the MOSFET even if a gate and a source of the output MOSFET are put in the same voltage, and a threshold voltage of the output MOSFET is smaller than that of an internal circuit MOSFET.

### CROSS-REFERENCE TO RELATED APPLICATION

The present application claims priority from Japanese Patent Application No. JP 2009-009890 filed on Jan. 20, 2009, the content of which is hereby incorporated by reference into this application.

### TECHNICAL FIELD OF THE INVENTION

The present invention relates to a semiconductor integrated circuit device. More particularly, the present invention relates to a semiconductor integrated circuit device enabling high speed and low power consumption.

### BACKGROUND OF THE INVENTION

It is well known that a threshold voltage Vt of a MOSFET must be lowered in order to achieve high speed under miniaturization and voltage lowering of MOSFETs, but the sub-threshold current (hereinafter, called “leakage current”) of the MOSFETs increases exponentially along with a lowering of the threshold voltage Vt. In a CMOSLSI using such a MOSFET, as means of interrupting the leakage currents generated in multiple MOSFETs in an internal circuit block (hereinafter, called “core”) in the CMOSLSI, for example, a power switch (Mpp0), such as that shown in Japanese Patent Application Laid-Open Publication No. H5-210976 (Patent Document 1), for interrupting a power-supply voltage VDD of the core when the core is inactive has been well known (FIGS. 2A-2B).

### SUMMARY OF THE INVENTION

In particular, characteristics of high speed, low noise and low power are required in a power switch shown in FIG. 2A in order to drive an internal power-supply wiring ND which is particularly large in parasitic capacitance by a large voltage VDD. For example, at a power-on time of the power-supply voltage, it takes a long time to recover an internal power-supply voltage from previous 0 V to the value of the power-supply voltage (VDD) of the core using the power switch having a finite driving ability. In addition, the fact that large noise is generated at respective portions inside (power-supply wirings, signal lines or substrates) at the power-on time is also a problem. This is because the next behavior must be waited until the noise disappears. Increase of power consumption in a case that such ON-OFF behavior of the internal power supply is continuously performed at high speed is also a problem. Further, when the power switch is completely turned off at an inactive time of the core, all nodes in the core become, for example, a ground level, so that logical states of the respective nodes are not retained. In order to store the logical states, a latch circuit is added to each node to retain its logical state immediately before turning-off the power switch, but the area of the core is increased corresponding to the addition of the latch circuit.

The above various problems can be solved by inserting the power switches between an external power supply and the core and between a ground and the core to set the power-supply voltage of the core obtained after the two power switches are turned off within a range from a voltage of the external power supply to the ground voltage (0V). Ideally, input and output voltages of the respective circuits in the core obtained after the power switches are turned off are set to about half the voltage of the external power supply, and the maximum effect is achieved by differentially driving two internal power-supply lines for providing the power-supply voltage of the core in the transient state upon turning on the power switches.

An active state in which high speed operation is performed and an inactive state in which a low leakage state is retained while the internal logical state is retained are realized, and transition between the two states can be realized at high speed with low noise and low power.

### BRIEF DESCRIPTIONS OF THE DRAWINGS

FIG. 1A is a circuit diagram illustrating a basic concept of an embodiment of the present invention;

FIG. 1B is an operational waveform diagram relating to FIG. 1A illustrating the basic concept of the embodiment of the present invention;

FIG. 2A is a circuit diagram illustrating a conventional power switch;

FIG. 2B is an operational waveform relating to FIG. 2B illustrating a conventional power switch;

FIG. 3 is a diagram illustrating a result of simulation to the embodiment of the present invention;

FIG. 4 is a circuit diagram illustrating a first modification of the circuit diagram illustrated in FIG. 1A of the present invention;

FIG. 5 is a circuit diagram illustrating a second modification of the circuit diagram shown in FIG. 1A of the present invention;

FIG. 6 is a circuit diagram illustrating a third modification of the circuit diagram shown in FIG. 1A of the present invention;

FIG. 7 is an operation waveform diagram illustrating a basic concept of another embodiment of the present invention; and

FIG. 8 is a circuit diagram illustrating a basic concept of another embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted. Though not particularly limited, transistors constituting respective blocks described in the embodiments of the present invention are formed on one semiconductor substrate such as single crystal silicon by integrated circuit technique, for example, technique of well-known CMOS (complementary metal-oxide transistor). That is, the transistors are formed according to a process including a step of forming a gate electrode and first and second semiconductor regions for source and drain regions are formed after a step of forming wells, device isolation regions and an oxide film.

Regarding a circuit symbol of a MOSFET (metal oxide semiconductor field effect transistor), the symbol with no arrow on a substrate denotes an N-type MOSFET (NMOS), which is distinguished from a P-type MOSFET (PMOS) with an arrow on a substrate. Incidentally, a MOSFET in the Specification is not limited to a field-effect transistor including an oxide film provided between a metallic gate and a semiconductor layer, and is used as one including a general FET such as a MISFET (metal insulator semiconductor field effect transistor) having an insulating film therebetween.

### First Embodiment

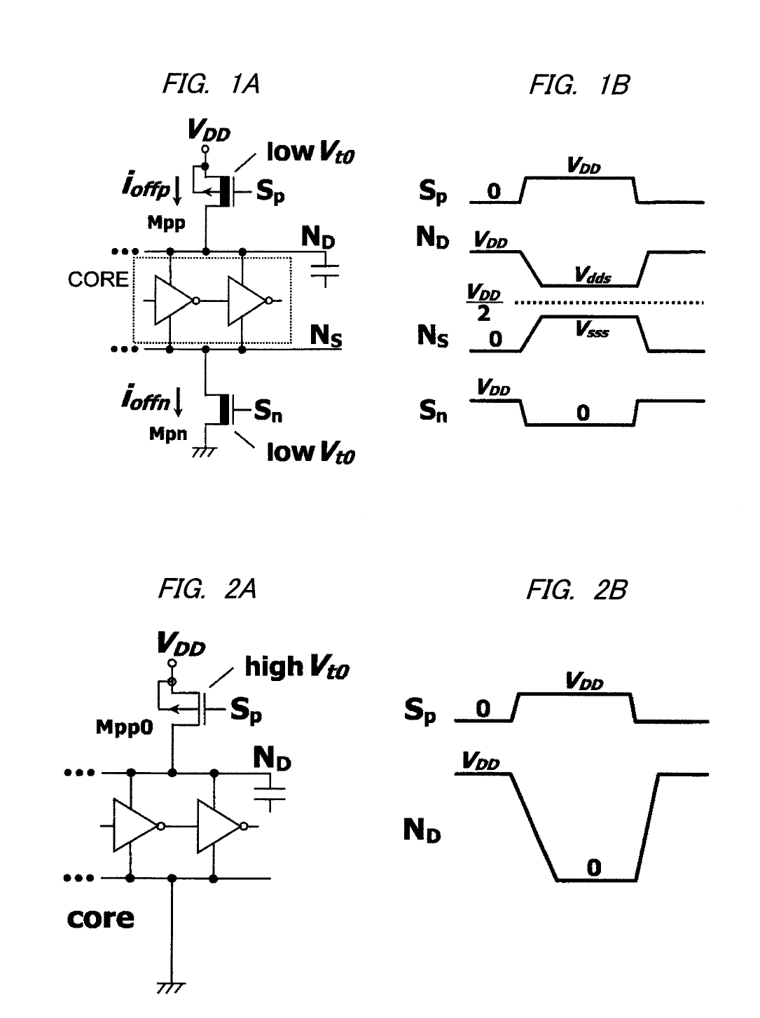

FIG. 1A is a circuit diagram and FIG. 1A is an operation waveform diagram illustrating a basic concept of the present invention. Power switches Mpp and Mpn whose output MOSFETs are pMOSFET and nMOSFET, respectively, are connected between two external power supplies VDD and VSS (ground voltage 0V) and an internal circuit block (CORE), and nodes of internal power-supply wirings are ND and NS, respectively. Channel lengths of the pMOSFET and nMOSFET for the switches are the same L, channel widths thereof are Wpp and Wpn, respectively, and absolute values of threshold voltages thereof are the same Vtp. In addition, total channel widths of the pMOSFET and nMOSFET in the core generating leakage currents simultaneously are Wcp and Wcn, respectively, and absolute values of threshold voltages of the pMOSFET and nMOSFET in the core are the same Vtc. At an active time of the core, the power switch MOSFETs are turned on, but generally the ON current must be sufficiently larger than an operating current of the core itself. Otherwise, the power-supply voltage of the core is lowered below the external voltage, operation of the core is adversely influenced by the insertion of the power switches. To avoid the adverse influence, the channel widths of the switch MOSFETs are made sufficiently larger than a total channel width of the MOSFETs which operate simultaneously in the core, or the threshold voltages of the switch MOSFETs are made smaller than those of the MOSFETs in the core. In view of downsizing the power switches, however, it is eventually more advantageous to set the threshold voltage Vtp of the power switch MOSFETs to be smaller than the threshold voltage Vtc of the MOSFETs in the core. Vtp may be smaller, for example, 0 V, or of a depression-type (normally-on) in the extreme.

In the design of the power switch, however, an OFF current at an inactive time of the core must be considered in addition to such an ON current of the power switch MOSFET as described above. Normally, at the inactive time, by applying a voltage equal to a source voltage to the gate of the power switch MOSFET, the MOSFET is turned off, and the OFF current is called as a leakage current of the MOSFET. It is known that the value is proportional to the channel width of the MOSFET and increases exponentially with respect to the decrease of the threshold voltage Vtp. Therefore, once the channel width and Vtp of the power switch MOSFET are determined, a large leakage current which the core itself is about to generate is suppressed to be equal to the OFF current of the power switch MOSFET.

That is, the internal power-supply voltage, namely, the power-supply voltage of the core decreases to satisfy such an equal current condition. More specifically, since a fixed voltage from the outside is applied on a substrate for each MOSFET, for example, a fixed voltage VDD from the outside is applied on the substrate for the pMOSFET in the core or a fixed voltage VSS from the outside is applied on the substrate for the nMOSFET in the core, source voltages are automatically changed to reversely bias more deeply to these fixed substrate voltages, that is, the threshold voltage of each MOSFET is increased to reduce the leakage current of the core. Therefore, the internal power-supply voltage comes close to the external power-supply voltage as the OFF current becomes larger than the leakage current of the core. For example, when the OFF currents of the two power switch MOSFETs in FIG. 1A are set to be equal to each other, differential voltages which fluctuate from a reference VDD/2 to positive and negative sides, respectively, appear on corresponding internal power-supply wirings ND and NS. That is, a voltage lowered by a constant value from VDD appears on the internal power-supply wiring ND, while a voltage raised by the constant value from VSS appears on the internal power-supply wiring NS. The more the OFF currents are reduced, the more the whole leakage current is suppressed, and the more the voltages of the internal power-supply wirings ND and NS come close to VDD/2. That is, the power-supply voltage of the core (that is, voltage difference between ND and NS (=Vdds−Vsss)) comes close to 0 V. By setting the power-supply voltage to be the minimum value or more by which logical states are stored in the latches and the like inside the core can be held, the logical states can be held while the leakage current is suppressed arbitrarily.

If the internal power-supply wirings ND and NS are controlled to be driven differentially in ON-OFF transit states of the power switches, the noise caused by capacitive coupling to another conductor, for example, the external power-supply lines (VDD, VSS), signal lines or the substrate is balanced out. In addition, a power-supply recovery period at the ON or OFF time or the setting time is short. The voltages of ND and NS change between VDD/2 and VDD or between VDD/2 and VSS, that is, the voltage amplitude is reduced to a half of the conventional voltage amplitude.

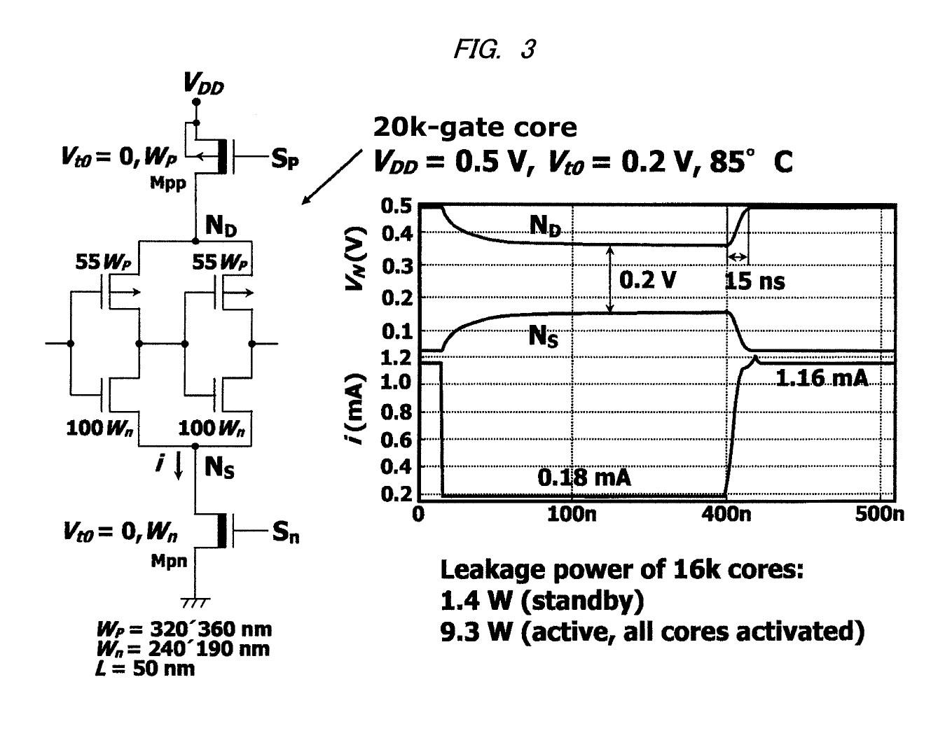

FIG. 3 is a result of simulation to an embodiment of the present invention. In the simulation, VDD=0.5 V, Vtc=0.2 V, 85° C., Vtp of power switch MOSFET=0 V, and channel length L=50 nm. Since a core is configured such that two stages of 20 k pieces of inverters of pMOS 320 nm and nMOS 240 nm connected in parallel are connected in series, a total channel width of the pMOSFETs in the core is 40000×320 nm, and a total channel width of the nMOSFETs in the core is 40000×240 nm, as illustrated in FIG. 3. A pMOSFET of a power switch is 320×360 nm and an nMOSFET of a power switch is 240×190 nm, therefore the area of the power switches is about 1% of the total area. As apparent from FIG. 3, when both the power switches are turned off by applying VDD to Sp and applying 0 V to Sn, ND and NS are changed toward VDD/2 and VSS, respectively, to become constant voltages. This is because the leakage current of the core is suppressed to 0.18 mA by the OFF currents of the power switch MOSFETs. When both the power switches are turned on by applying VSS to Sp and applying VDD to Sn, ND and NS are recovered to VDD and VSS in about 15 ns, respectively. When the both power switches are turned on, the leakage current of the core is 1.16 mA. That is, if there is no power switch, the leakage current of the core flowing at 1.16 mA is reduced to 0.18 mA by turning off the power switches. Since ND and NS are operated differentially at the ON/OFF time, the above advantage can be obtained.

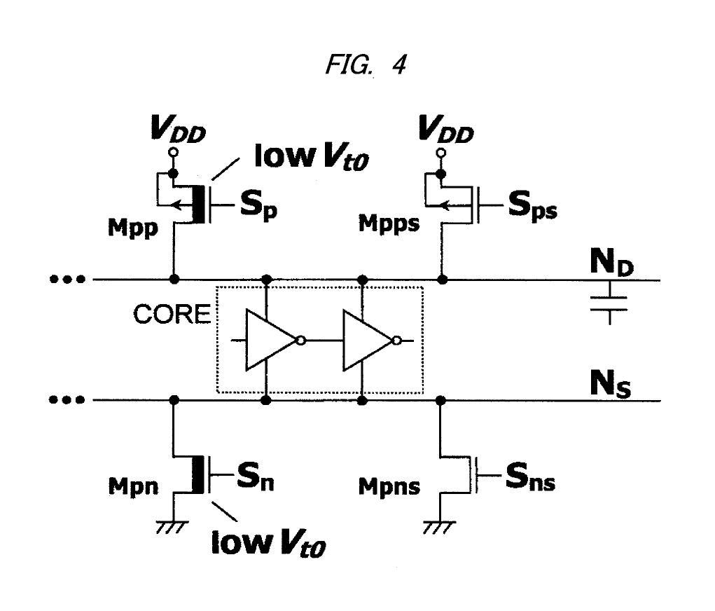

FIG. 4 illustrates an example in which MOSFETs dedicated for the OFF time are added in parallel in order to further reduce the leakage current at the OFF time. The MOSFETs Mpp and Mpn having large channel widths and small Vtp are turned on at the ON time as described above, and both the MOSFETs are completely turned off and the OFF currents are further given to the core from Mpps and Mpns which are MOSFETs having channel widths at the OFF time. Thereby, the power switches can give the core a large ON current and a small OFF current which are independent of each other. Therefore, the leakage current at the OFF time can be made smaller than 0.18 mA mentioned above. To turn off Mpp and Mps completely at the OFF time of the power switches, it is only necessary to apply a sufficiently-high voltage which is equal to VDD or more or a sufficiently-deep negative voltage which is equal to VSS or less to the respective gates. Moreover, as Mpps and Mpns, MOSFETs having the same threshold voltage as the MOSFETs in the core can be used.

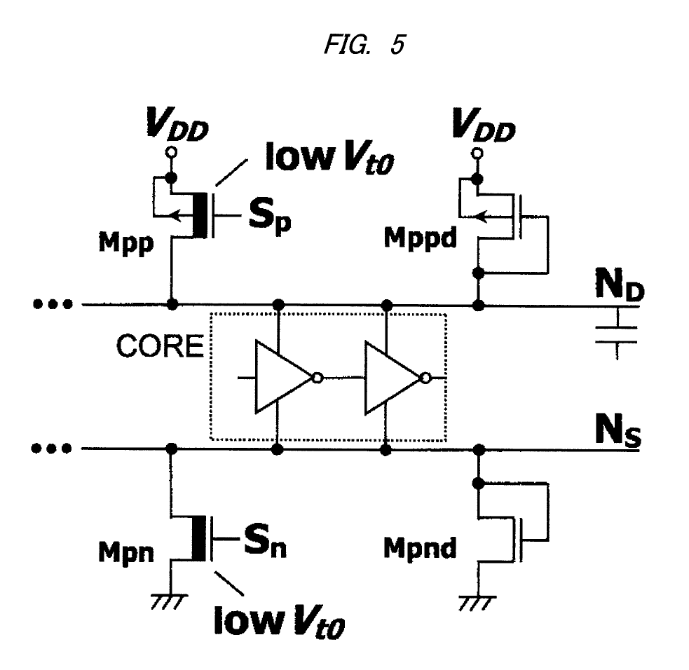

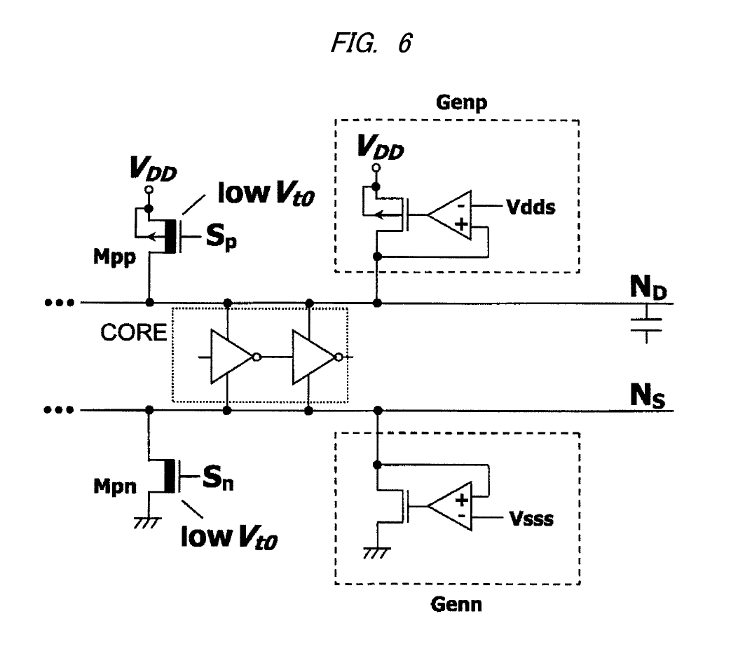

Further, since slight OFF currents are only provided, diode connections (Mppd, Mpnd) may be adopted, as illustrated in FIG. 5. In addition, in place of Mpps and Mpns, as illustrated in FIG. 6, voltage generating circuits (Genp, Genn) which generate constant voltages may be used. As described above, if each of the voltages of the power-supply nodes ND and NS is set to about a half of the external power-supply voltage, and the power-supply voltages are set to be the minimum value or more by which logical states stored in the latches and the like inside the core can be retained, the logical states can be held while the leakage current is arbitrarily suppressed, but it is difficult to design the state with the gate widths or the gate lengths and threshold voltages of MOSFETs forming the power switches. In an embodiment in FIG. 6, this design can be simplified by performing the voltage setting (in FIG. 1B, Vdds and Vsss) actively in the voltage generating circuit.

### Second Embodiment

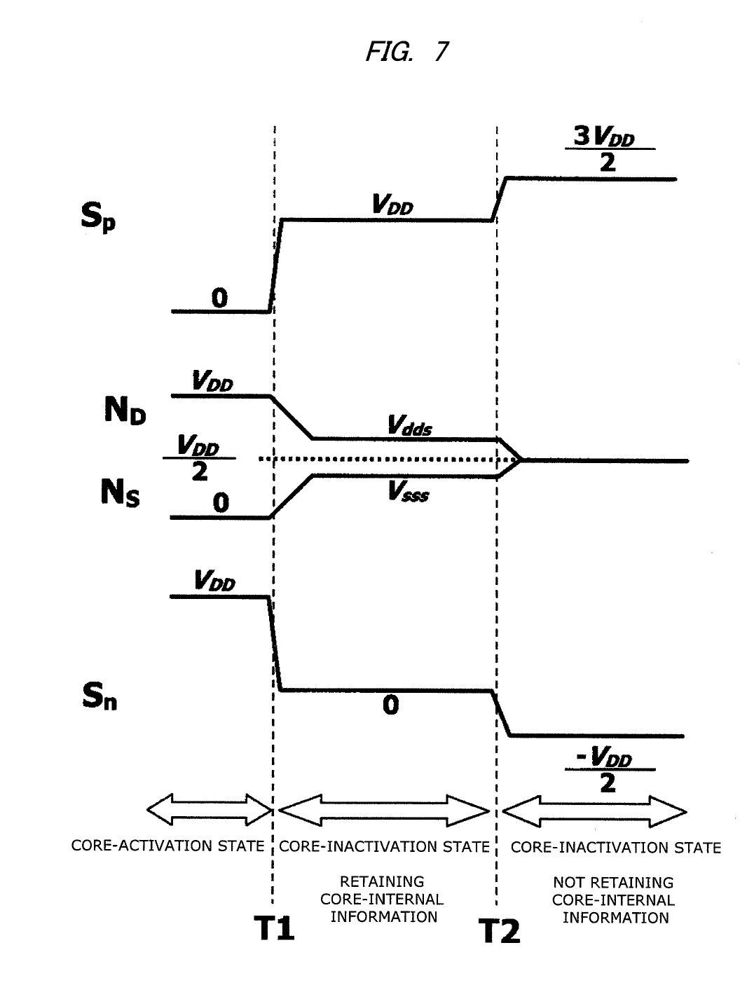

FIG. 7 illustrates another embodiment of a controlling method of the power switches in FIG. 1. The second embodiment is the same as the embodiment in FIG. 1B until time T2, but after time T2, 1.5 VDD which is larger than or equal to VDD and −0.5 Vdd which is smaller than or equal to VSS are applied to the gate electrodes of Mpp and Mpn, respectively. Though the logical states in the core cannot be retained, the leakage current of the core can be reduced as compared with that from time T1 to time T2. Since Mpp and Mpn are put into completely-OFF states, the voltages of the power-supply nodes ND and NS come close to the voltage of VDD/2, but at this time, withstanding voltages of the power switches can be the same as those of the MOSFETs constituting the core since differences in potential between respective terminals of the sources, the drains, and the gates of the output MOSFETs (Mpp and Mnn) of the power switches do not exceed VDD. Here, the power-supply nodes ND and NS can be driven to VDD/2 actively by the voltage generating circuit such as that used in FIG. 6, for example. The design can be simplified from the same reason as in FIG. 6. Incidentally, respective specific values of the abovementioned 1.5 Vdd, −0.5 Vdd and VDD/2 are not particularly limited to these values. It is needles to say that the problem of withstanding voltage is solved and the same effect can be realized similarly by adjusting specific values around these values properly.

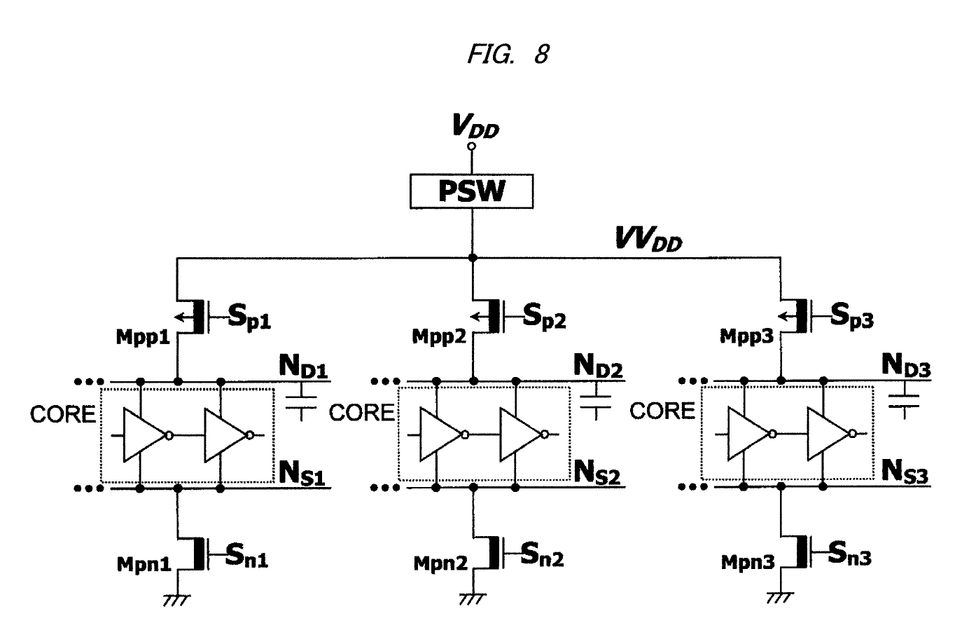

FIG. 7 illustrates an embodiment for realizing a state in which the logical state of the core are not retained (OFF state) in contrast to the embodiment in FIG. 1. Meanwhile, in order to realize the state, a power-supply shutdown circuit PSW (though not particularly limited, it can be formed of a MOSFET or the like) for cutting off the leakage current completely at the OFF time in FIG. 1A is added in series, and the power-supply shutdown circuit PSW may be driven to an OFF state (state in which the leakage current is sufficiently small) at the OFF time. As a specific example, FIG. 8 illustrates an example in which one power-supply shutdown circuit PSW is hierarchically added to a plurality of circuits illustrated in FIG. 1. While a frequent and fine-graded reduction of the leakage current by a power switch such as a gated clock is achieved by putting Mpp1 to Mpp3 and Mpn1 to Mpn3 into OFF states as illustrated in FIG. 1B, a reduction of the leakage current for a certain long time period is performed by putting the power-supply shutdown circuit PSW into an OFF state, thereby the power consumption as a whole system can be efficiently reduced. In an inactive state for a certain long time period, the total power consumption can be reduced in a case of including restoring internal information by means for achieving OFF states with a small amount of leakage current though not retaining information rather than by the means described in FIG. 1A for retaining information inside the core with retaining a small amount of leakage current. In such a case, it is preferable to adopt the former means. Incidentally, the power-supply shutdown circuit is disposed on the side of VDD, but it may be disposed on the side of VSS.

Incidentally, the setting of the threshold voltage of the output MOSFET to be smaller than the threshold voltage of the MOSFETs in the internal circuit block also produces a similar effect in a case of providing one ordinary power switch.

In a case of using MOSFETs which have a small threshold voltage and a large threshold voltage in a core, the small threshold voltage can be utilized for the output MOSFETs (Mpp, Mpn) in the power switches. Smaller threshold voltage is preferable for low-voltage operation, and as is well known, there is such an advantage that further lower voltage can be achieved since the fluctuation of threshold voltage becomes small.

In the foregoing, the invention made by the inventors of the present invention has been concretely described based on the embodiments. However, it is needless to say that the present invention is not limited to the foregoing embodiments and various modifications and alterations can be made within the scope of the present invention. For example, only in view of achieving a low leakage at the inactive time and retaining the states inside the core, it is unnecessary to provide the power switches to both of the inner power-supply wirings ND and NS, and such a configuration can be employed that a power switch is provided to only one of the internal power-supply wirings ND and NS.

What is claimed is:

1. A semiconductor integrated circuit device comprising: an internal circuit block including a plurality of circuits and a power control circuit which controls a power-supply voltage of the internal circuit block, the internal circuit block and the power control circuit being disposed between a first power-supply line for applying a first external power-supply voltage and a second power-supply line for applying a second external power-supply voltage, wherein
the control circuit includes an output MOSFET,
a constant OFF current flows in the output MOSFET even if a gate and a source of the output MOSFET are at the same voltage, and
a threshold voltage of the output MOSFET is smaller than that of an internal circuit MOSFET.

2. The semiconductor integrated circuit device according to claim 1, wherein,
in a case in which the internal circuit MOSFET has a first MOSFET having a first threshold voltage and a second MOSFET having a second threshold voltage which is smaller than the first threshold voltage, the threshold voltage of the output MOSFET is the second threshold voltage.

3. A semiconductor integrated circuit device comprising: an internal circuit block including a plurality of circuits and a power control circuit which controls a power-supply voltage of the internal circuit block, the internal circuit block and the power control circuit being disposed between a first power-supply line for applying a first external power-supply voltage and a second power-supply line for applying a second external power-supply voltage, wherein
the control circuits are connected between the internal circuit block and the first power-supply line and between the internal circuit block and the second power-supply line, respectively,
the control circuit includes an output MOSFET,
a constant OFF current flows in the output MOSFET even if a gate and a source of the output MOSFET are at the same voltage, and,
after the output MOSFET is turned off, the power-supply voltage inside the internal circuit block is set between the first external power-supply voltage and the second external power-supply voltage.

4. The semiconductor integrated circuit device according to claim 3, wherein OFF currents of the respective output MOSFETs of the two power control circuits are substantially equal to each other.

5. The semiconductor integrated circuit device according to claim 3, wherein an input/output voltage of each circuit after the output MOSFET is turned off takes a value of substantially a half of an external power-supply voltage.

6. The semiconductor integrated circuit device according to claim 3, wherein, after the output MOSFET is turned off or on, an internal power-supply line on the side of the external power-supply voltage of the internal circuit block and an internal power-supply line on the ground side are substantially differentially driven.

7. The semiconductor integrated circuit device according to claim 3, wherein an external power-supply voltage is applied to a substrate for MOSFETs in the internal circuit block.

8. The semiconductor integrated circuit device according to claim 3, wherein the power-supply voltage of the internal circuit block after the output MOSFET is turned off is set to be a minimum value or larger by which logical states of the circuits in the internal circuit block can be retained.

9. The semiconductor integrated circuit device according to claim 3, wherein a threshold voltage of the output MOSFET is set to be smaller than that of a MOSFET in the internal circuit block.
